(19) United States
(12) Patent Application Publication
(10) Pub. No.: US 2017/0189924 A1
(43) Pub. Date: Jul. 6, 2017

(54) DEVICE TO CLOSE THE OUTLET MOUTH OF A FLUID DISPENSER, IN PARTICULAR A FLUID DISPENSING HEAD FOR FLUIDS, SUCH AS PAINTS

(71) Applicants: Luca DROCCO, Alba (CN) (IT); Mario DROCCO, Alba (CN) (IT)

(72) Inventors: Luca DROCCO, Alba (CN) (IT); Mario DROCCO, Alba (CN) (IT)

(21) Appl. No.: 15/308,812

(22) PCT Filed: Apr. 30, 2015
(86) PCT No.: PCT/IB2015/053138

§ 371 Date: Nov. 3, 2016

(30) Foreign Application Priority Data
May 5, 2014 (IT) TO2014A000359

(51) Int. Cl. B05B 15/02; B05B 15/00; B67C 3/00; B01F 15/02

(52) U.S. Cl. CPC B05B 15/02; B01F 15/02; B05B 15/0208; B05B 15/001; B67C 3/004

(57) ABSTRACT

A device includes a rotary portion, which is mounted so as to rotate on a support structure around a rotation axis (X-X) between an angularly moved away condition and an angularly moved close condition relative to an outlet mouth. A shutter portion pivots relative to the rotary portion around a pivoting axis (Y-Y) lying on a plane that is transverse relative to the rotation axis (X-X). An actuating apparatus moves the rotary portion between the moved away condition and the moved close condition. The shutter portion is suited to pivot around the pivoting axis (Y-Y) from an open position, in which the shutter portion is spaced apart from the outlet mouth, to a closed position, in which the shutter portion lies against the outlet mouth, when the rotary portion shifts from the moved away condition to the moved close condition.

### TECHNICAL FIELD

The present invention relates to a device for colosing the outlet mouth of a fluid dispenser, in particular a fluid dispensing head for fluids, such as paints, dyes, additives or chemical components in general.

### TECHNOLOGICAL BACKGROUND

In the field of fluid dispensing machines, it is known the use of closing devices designed for closing the outlet mouth of a fluid dispenser, typically provided with at least one dispensing nozzle, when the relative machine has ended the dispensing operation. In this way, one can prevent the fluid located close to the outlet mouth of the nozzle from remaining exposed to the air, thus being liable to deterioration.

The use of closing devices of the above mentioned type has especially spread in the field of paints and varnishes, in which skilled people typically use machines comprising a dispensing head provided with a plurality of nozzles, for dispensing fluids with different properties and/or colors, for example by collecting dosed quantities of these fluids in a receptacle to obtain a mixture with the desired composition. As a matter of fact, the fact that the fluid located close to the outlet mouth remains exposed to the air for a long time can cause it to dry. This drawback is particularly noticeable, when there is the need to dispense last generation paints, additives, dyes or varnishes. In fact, some fluids, among which there are also modern paints, in order to observe latest anti-pollution regulations, have chemical compositions that force them to immediately dry when they are exposed to the air. If the fluid dries due to the undesired exposition to air, it is necessary to mechanically remove deposits, for example by means of brushes, or to periodically carry out bleeding operations. These operations generally are difficult and not very functional.

Therefore, closing elements, such as plugs, cups or the like, were developed, which are able to move and close the outlet mouth of the dispensing head, in an attempt to avoid or limit the exposition to the air, once the dispensing machine has ended its own operations. Some of these plugs, in their movement towards a closed condition, slide against the nozzles, or anyway pass so close to them that they come into contact with drops of fluid hanging from said nozzles. As a consequence, the fluid close to the outlet hole of a nozzle is removed by the moving plug, which brings it into contact with other nozzles or with drops of a different fluid, thus causing an undesired contamination among fluids.

This drawback is clearly counterproductive, even more so in the field of paint dosing, in which each nozzle generally dispenses a respective colored fluid; as a matter of fact, if the end of a nozzle is contaminated by traces of other colors, the final product, consisting of a mixture of different colors, will have a color that is different from the desired one.

### SUMMARY OF THE INVENTION

An object of the present invention is to provide a device for closing the outlet mouth of a fluid dispenser, which is able to solve the drawbacks of the prior art and, at the same time, can be manufactured in a simple and economic way.

In particular, one of the objects of the present invention is to avoid an undesired exposition of the outlet mouth of the fluid dispenser to the external environment.

According to the present invention, this and other objects are reached by means of a device having the features set forth in appended independent claim..

The appended claims are an integral part of the technical teaches provided in the following detailed description concerning the present invention. In particular, the appended claims define some preferred embodiments of the present invention and describe optional technical features.

Further features and advantages of the present invention will be best understood upon perusal of the following detailed description, which is provided by way of example and is not limiting, with reference, in particular, to the accompanying drawings, which are briefly described below.

### BRIEF DESCRIPTION OF THE DRAWINGS

FIG. 1 is a perspective view from the bottom of a fluid dispenser having an outlet mouth, in particular of a fluid dispensing head, whose outlet mouth is provided with a plurality of holes or nozzles, adapted to dispense fluids having different properties (for example, the fluids can be paints of different colors). This fluid dispenser is provided with a device for closing its outlet mouth, which is manufactured according to an explanatory embodiment of the present invention.

FIG. 2 is a perspective view from the top of the sole device for closing the outlet mouth (without the dispenser that can be associated with it) according to a further embodiment of the invention.

FIG. 3 is an exploded perspective view of the device shown in FIG. 1.

FIG. 4 is a plan view from the top of the device shown in FIGS. 1 and 3.

FIG. 5 is a a lateral elevation view of the device shown in FIGS. 1, 3 and 4.

FIG. 6 is a cross-section view of the device shown in FIG. 5. This figure was obtained by means of a cross-section along a plane indicated by line VI-VI shown in FIG. 5.

FIGS. 7 and 7a are, respectively, a plan view from the bottom and a lateral elevation view of the dispenser, on which there is assembled the device shown in the previous figures. The dispenser and the device for closing its outlet mouth are shown in an operating configuration, which is substantially similar to the one shown in FIG. 1.

FIGS. 8 and 8a are, respectively, a plan view from the bottom and a lateral elevation view of the dispenser, on which there is assembled the device shown in the previous figures. The dispenser and the device for closing its outlet mouth are shown in another operating configuration, which is different from the one shown in FIGS. 1 and 7, 7a.

FIG. 9 is an exploded perspective view of the device according to a further embodiment.

### DETAILED DESCRIPTION OF THE INVENTION

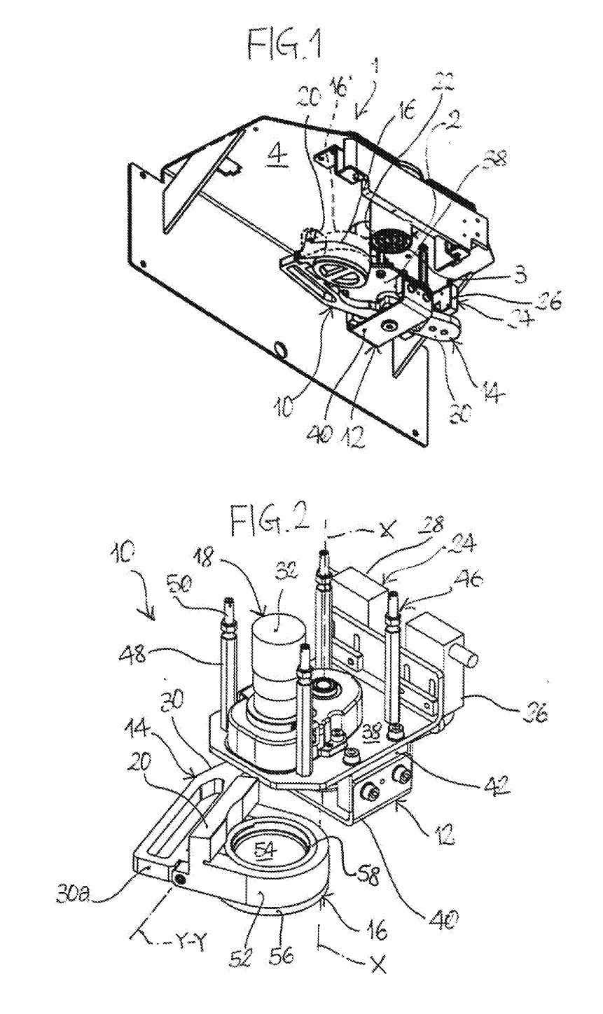

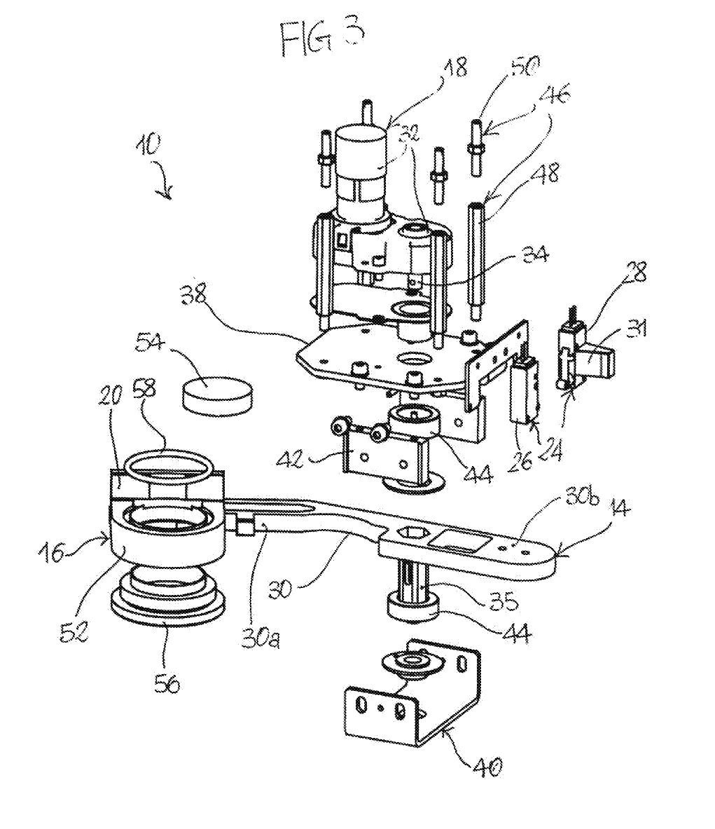

With reference, in particular, to FIGS. 1, 7, 7a, 8, 8a, number 1 indicates, as a whole, an explanatory type of fluid dispenser.

According to the drawings, fluid dispenser 1 comprises an outlet mouth 2, which - by mere way of non-limiting example for the purposes of the present invention - is the distal end of a dispensing head provided with a plurality of holes or nozzles 3, each for dispensing a fluid having properties that are different from the ones of the other nozzles (in particular, wherein the nozzles are designed to be flown through by different colors). In the example shown, the plurality of nozzles 3 are slightly recessed relative to the distal end (outlet mouth 2) of the dispensing head, whose periphery projects axially.

Based on what is approximately shown in the drawings, fluid dispenser 1 has a substantially tubular shape and projects downwards from the bottom of a bracket or overhang 4 carried by a frame (details that are not shown), which is designed to support it.

As shown in the figures mentioned above, fluid dispenser 1 is provided with a device 10 for closingits outlet mouth 2.

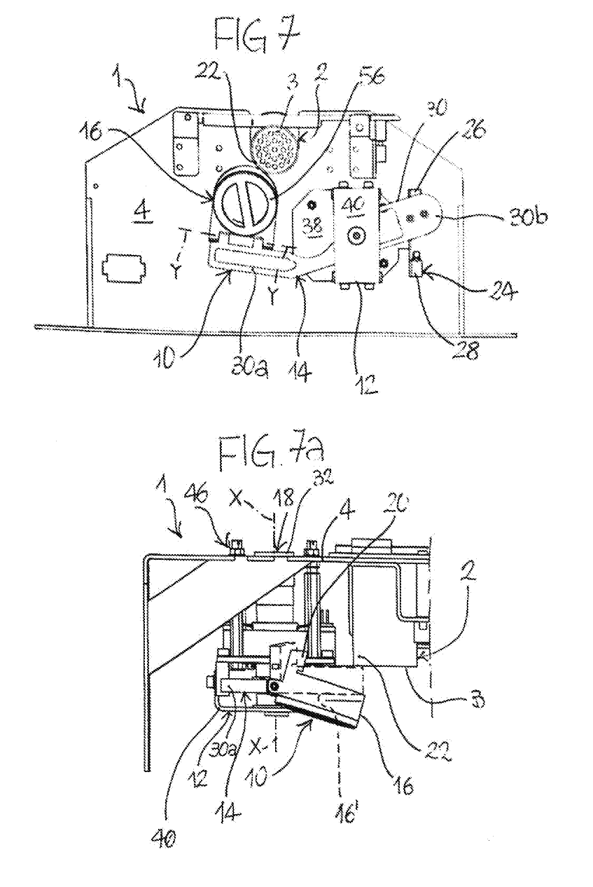

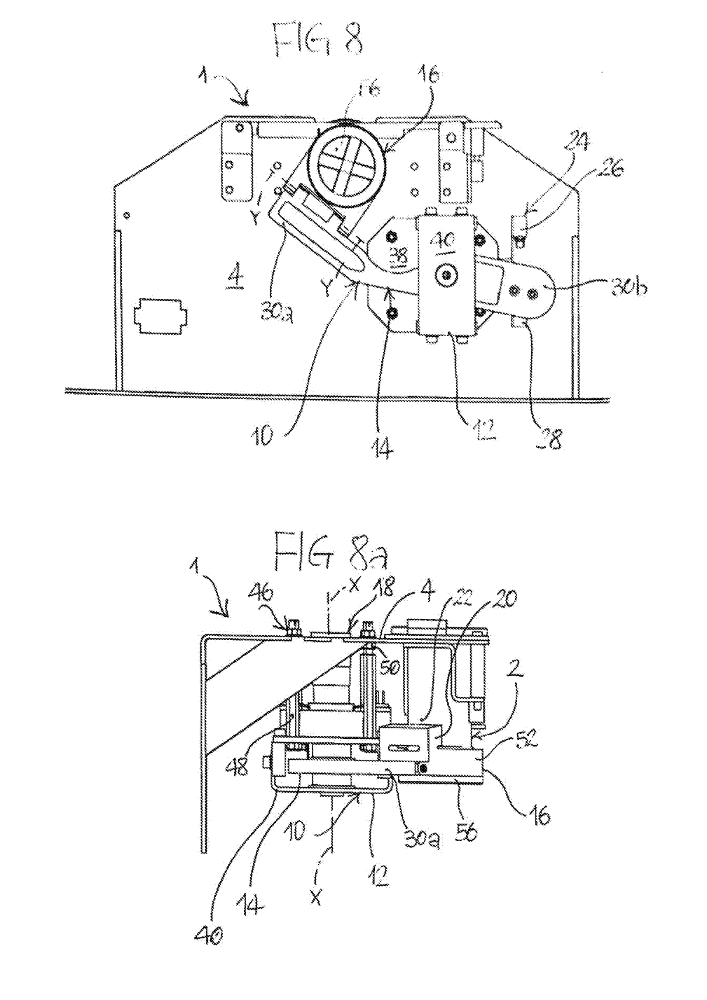

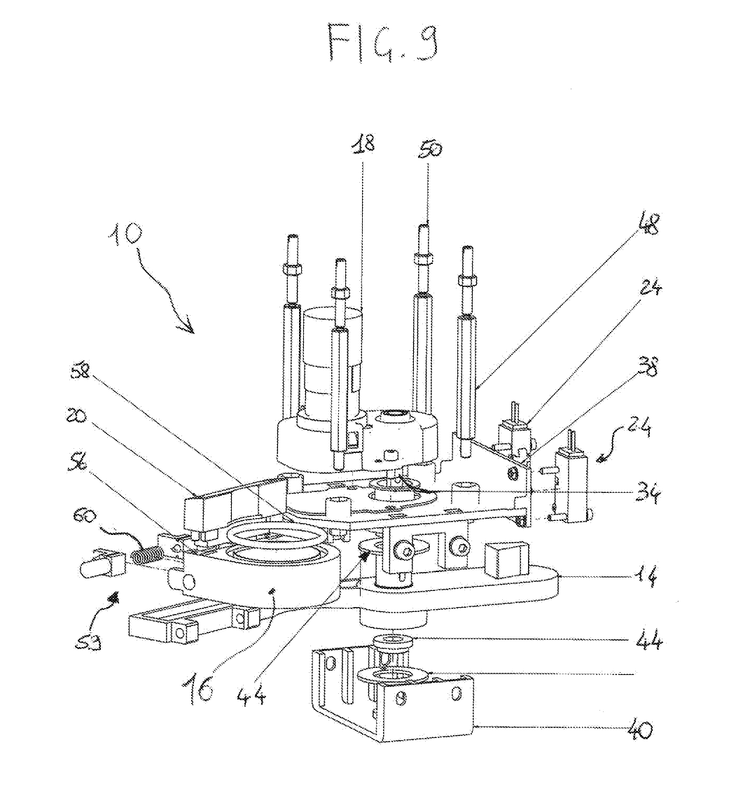

According to the embodiment of the present invention, shown by way of example, device 10 comprises:
a support structure 12;
a rotary portion 14, which is mounted so as to rotate on the support structure 12 around a rotation axis X-X between an angularly moved away condition (FIGS. 1, 7 and 7a) and an angularly moved close condition (FIGS. 8 and 8a) relative to outlet mouth 2;
a shutter portion 16, which pivots relative to rotary portion 14 around a pivoting axis Y-Y lying on a plane that is transverse relative to rotation axis X-X (in particular, pivoting axis Y-Y is neither parallel to nor coinciding with rotation axis X-X); and
an actuating apparatus 18, for moving rotary portion between the moved away condition and the moved close condition.

Shutter portion 16 is suited to pivot around pivoting axis Y-Y between an opening position (FIGS. 1, 7 and 7a), in which it is spaced apart from outlet mouth 2, thus freeing it, and a closed position, in which it lies against said outlet mouth 2, thus obstructing it, when said rotary portion 14 shifts from the moved away condition to the moved close condition.

Thanks to the technical features mentioned above and as we will better explain below, device 10 is able to close outlet mouth 2 (in the case shown by way of example, belonging to the dispensing head) in a reliable manner and with a structure that, in general, can be manufactured in a simple and economic fashion, thus significantly reducing the drawbacks of the prior art.

In order to provide a complete picture, the pivoting movement carried out by shutter portion 16 relative to rotary portion 14 and to the outlet mouth is schematically shown in FIGS. 1 and 7a, in which the outline of the shutter portion is shown, with a solid line, in the opening position (which corresponds to the actual position in which the shutter portion would be in the operating conditions shown) and is indicated with number 16. Furthermore, in the aforesaid figures, the outline of the shutter portion is also shown, with a broken line, in the closing position and is indicated with number 16′.

Therefore, in the embodiment shown, when the shutter portion is in the opening position - indicated with 16—it is tilted downwards. On the other hand, when the shutter portion is in the closing position - indicated with 16′—it is lifted upwards; in particular, when the shutter portion is in the closed position under outlet mouth 2, it is in contact with the latter and substantially prevents it from communicating with the external environment.

Preferably, rotation axis X-X is substantially orthogonal to the plane on which pivoting axis Y-Y lies.

In the embodiment shown, shutter portion 16 comprises a striker area 20, adapted to be pushed by a corresponding supporting portion 22, when rotary portion 14 moves from said moved away condition to said moved close condition, so as to cause shutter portion 16 to rotate, thus shifting from the opening position to the closed position.

In the embodiment shown, supporting portion 22 is carried by fluid dispenser 1 itself, so that—when striker area 20 angularly reaches the position of the dispenser (which corresponds to the moved close condition of rotary portion 14)—the supporting portion 22 provides a push that causes shutter portion 16 to pivot moving close to outlet mouth 2 (in particular, lifting it). Preferably, supporting portion 22 is carried by the lateral surface of the fluid dispenser and, more preferably, supporting portion 22 is made up of said lateral surface. However, in alternative embodiments (not shown), the supporting portion can also be located in positions that are different from the one shown in the annex drawings. For example, in one of these embodiments, the supporting portion can be carried by the support structure of the device, in particular it can be a projection of the support structure, which is designed to hit the striker area of the shutter portion (details that are not shown), when the rotary portion reaches the moved close condition.

In the embodiment shown, device 10 comprises, furthermore, detecting means 24, which cooperate with rotary portion 14 and are designed to signal that rotary portion 14 is in at least one condition between the moved away condition and the moved close condition. In particular, detecting means 24 comprises at least one switch (preferably, for example, a microswitch) or a proximity sensor or a photodetector, adapted to be operated by rotary portion 14, when rotary portion 14 reaches at least one condition between the moved away condition and the moved close condition. In particular, rotary portion 14 comprises at least one projection or appendage, which is able to activate said switch, when it reaches at least one between the aforesaid conditions.

Detecting means 24 preferably comprise an opening switch 26 and a closing switch 28, capable of being operated by rotary portion 14, when the latter reaches the moved away condition and the moved close condition, respectively. Preferably, at least one of switches 26, 28 is a microswitch. In the embodiment shown, both switches 26, 28 are microswitches.

As an alternative to the preferred embodiment, said detecting means can be implemented with opening sensors, such as, for example, proximity sensors or photodetectors. In the description, reference is made, by way of example, to switches.

In particular, opening switch 26 and closing switch 28 work as limit switch, since they are activated by rotary portion 14, which, for example, is provided with at least one projection or appendage, which is properly dimensioned so as to alternately rest against opening switch 26 and closing switch 28, when said projection or appendage reaches the opening position and the closed position. In this way, switches 26, 28 help interrupting the operation of actuating apparatus 18, once rotary portion 14 has reached the corresponding position.

Should proximity sensors or photodetectors be used, said at least one projection or appendage is properly dimensioned so as to get close to the respective opening/closing sensor.

Preferably, switches 26 and 18 are fixed to support structure 12, for example they are screwed onto it. In the embodiment shown, rotary portion 14 comprises a lever 30, which is mounted so as to rotate around said rotation axis X-X.

Preferably, lever 30 comprises a support arm 30a, on which shutter portion 16 is mounted and, in particular, hinged so as to pivot around pivoting axis Y-Y.

FIG. 9 shows an embodiment in which shutter portion can be removed from rotary portion 14. In particular, there is a quick release system 59 comprising pliable elements, such as elastic elements (e.g. a helical spring 60) to disengage shutter portion 16 from rotary portion 14.

Preferably, lever 30 comprises a detecting arm 30b, which cooperates with detecting means 24, in particular with opening switch 26 and with closing switch 28. In the embodiment shown, detecting arm 30b comprises a projection 31, for example a wedge-shaped one, adapted to strike against a sensitive organ (such as a roller or a pivoting element operated by pressure) of switches 26 and 28, when the it reaches the opening position and the closed position, respectively. In particular, projections 31 is fixed to the top of detecting arm 30b, for example by means of screws.

In the embodiment shown, lever 30 is a rocker arm, which is supported by support structure 12 so as to rotate around rotation axis X-X, and wherein support arm 30a and detecting arm 30b project relative to rotation axis X-X. In particular, arms 30a and 30b are not mutually angularly equally spaced apart, but they have an asymmetrical arrangement relative to axis X-X. In further embodiments of the present invention that are not shown herein, the lever can also be a one-arm lever, which supports the pivoting movement of the shutter portion and, at the same time, cooperates with the detecting means; in other words, in this possible embodiment, the support arm and the detecting arm substantially coincide with this lever. In this embodiment, arm 30a is adapted to cooperate with detecting means 24.

Optionally, at least one between support arm 30a and detecting arm 30b is provided with slots or windows, adapted to lighten the weight of the overall structure of lever 30, thus facilitating its rotation.

In the embodiment shown, the actuating apparatus 28 comprises a motor assembly 32 (for example an electrically operated one), adapted to control the rotation of rotary portion 14 around rotation axis X-X. Preferably, motor assembly 32 comprises a motor and a transmission (such as a gear), cooperating at the output of the motor, adapted to form a reduction gear assembly. In alternative embodiments, it is also possible to use an actuator to control the movement of the rotary portion relative to rotation axis X-X; for example, one can use a linear actuator acting upon the rotary portion, in particular upon the lever, in a position that is radially spaced apart relative to rotation axis X-X.

In the embodiment shown, motor assembly 32 controls the rotation of an output shaft 34, which is caused to rotate around rotation axis X-X together with rotary portion 14 in an integral manner. Preferably, output shaft 34 is caused to rotate around rotation axis X-X together with lever 30 in an integral manner, in particular together with an intermediate part thereof, from which support arm 30a and detecting arm 30b project.

With reference to FIG. 6, in the embodiment shown, output shaft 34 is axially constrained to a prismatic pin 35 by means of a cross peg 36. Prismatic pin 35, in turn, is splined on the inside of an opening with a corresponding shape obtained in lever 30, in particular in a central part thereof, from which support arm 30a and detecting arm 30b project.

In the embodiment shown, prismatic pin 35 is hollow and houses, on the inside, a part of the end of output shaft 34; in particular, cross peg 36 extends through both prismatic pin 35 and output shaft 34 housed therein.

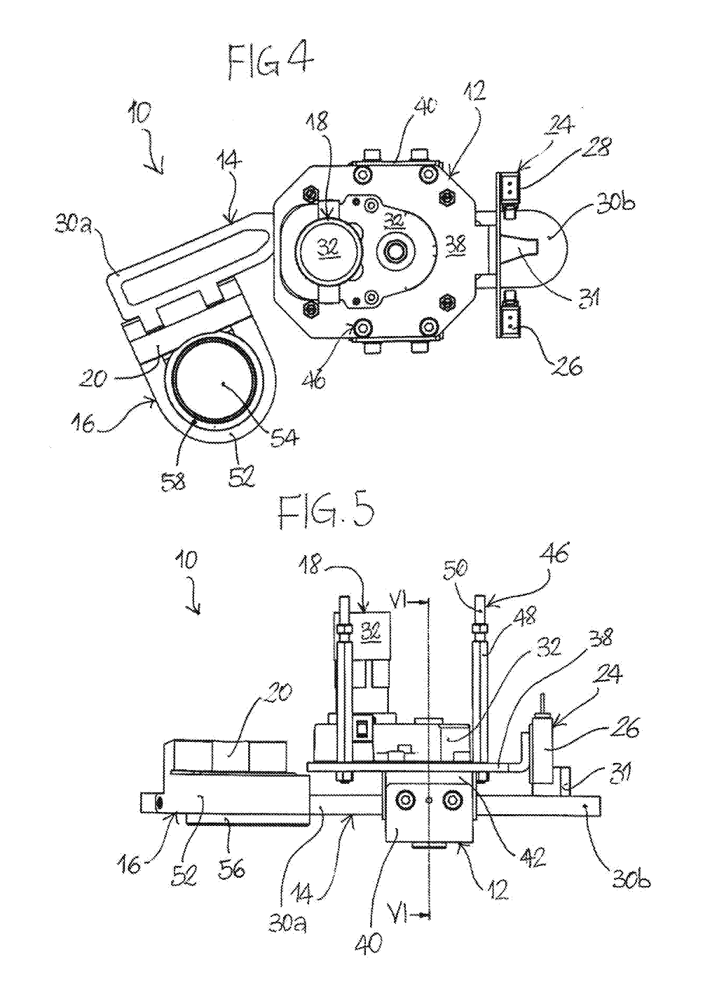

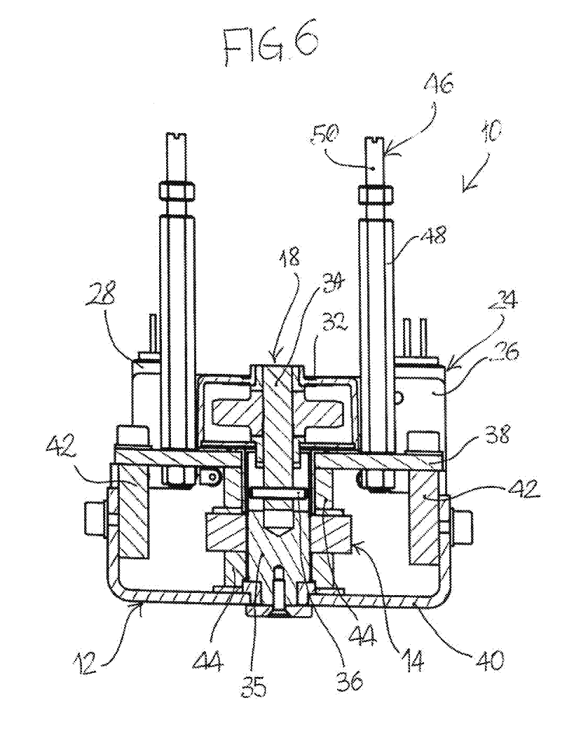

With reference, in particular, to FIGS. 3 and 6, in the embodiment shown, support structure 12 comprises a top plate 38 and a bottom bracket 40, which are mutually connected and between which lever 30 is supported so as to rotate. Preferably, the connection between top plate 38 and bottom bracket 40 is obtained by means of a pair of lateral spacers 42, which are fixed, on one side, to top plate 38 and, on the other side, to each one of the lateral branches of bottom bracket 40. In particular, each one of lateral spacers 42 is axially connected (for example, by means of screws) to top plate 38 and is transversely connected (for example, by means of screws) to a respective lateral branch of bottom bracket 40. Alternatively, lateral spacers 42 are manufactured as one single piece together with top plate 38 and are coupled to bottom bracket 40 through fixing means.

With reference, in particular, to FIGS. 3 and 6, in the embodiment shown, lever 30 is supported in its rotation around rotation axis X-X on support structure 12 by a pair of bushings 44, which are arranged on axially opposite sides of the lever. In particular, one of bushings 44 is axially interposed between top plate 38 and a central portion of lever 30, whereas other bushing 44 is axially interposed between the central portion of lever 30 and bottom bracket 40. For example, bushings 44 house, on the inside and with freedom of rotation, axially opposite parts of at least one between output shaft 34 and prismatic pin 35, which output shaft and prismatic pin extend through the central part of lever 30 (between arms 30a, 30b).

In the embodiment shown, said sensor means are fixed to top plate 38.

In the embodiment shown, the device 10 comprises an adjusting system 46, adapted to adjust the orientation and/or the distance of support structure 12 relative to outlet mouth 2.

Preferably adjusting system 46 comprises at least one upright 48, fixed to support structure 12, in particular to top plate 38, and is connected to dispenser 1, in particular to overhang 4, in an adjustable manner. In the embodiment shown, adjusting system 46 comprises a plurality of uprights 48. In particular, the connection between at least one upright 48 and dispenser 1 is made through the interposition of a corresponding adjusting screw 50, adapted to adjust the distance between upright 48 and fluid dispenser 1 (in this example, its overhang 4).

In the embodiment shown, striker area 20 is a projection carried by shutter portion 16, adapted to strike against the supporting portion 22 (in this example, made up of the lateral surface of fluid dispenser 1), thus determining the pivoting movement of shutter portion 16 to the closed position. In particular, this projection projects from the top of shutter portion 16.

In the embodiment shown, shutter portion 16 comprises, furthermore, a holding tank 52 and a tampon 54, which is inserted into the holding tank 52 and adapted to be soaked with a liquid, so as to prevent the fluid located close to outlet mouth 2 from drying up, when shutter portion 16 is in the closed position.

Preferably, shutter portion 16 has a bottom 56 that can be coupled to holding tank 52 in a removable manner.

Optionally, shutter portion 16 also comprises a gasket 58, capable of ensuring a better sealing between outlet mouth 2 and holding tank 52. In particular, gasket 58 is advantageously coupled to the top edge of holding tank 52.

In the embodiment shown, when shutter portion 16 moves to the closed position, holding tank 52 rests against outlet mouth 2, if necessary causing the holding tank to house the terminal part of fluid dispenser 1. Optionally, the terminal part of fluid dispenser 1 can rest against tampon 54 contained in holding tank 52 and/or the gasket can be interposed between the edge of holding tank 52 and the edge of outlet mouth 2 (or of the end of fluid dispenser 1).

Naturally, the principle of the present invention being set forth, embodiments and implementation details can be widely changed relative to what described above and shown in the drawings as a mere way of non-limiting example, without in this way going beyond the scope of protection provided by the accompanying claims.

1. A device to close an outlet mouth of a fluid dispensing head for fluids such as paints; said device comprising:
support structure;
a rotary portion, mounted so as to rotate on said support structure around a rotation axis between a angularly moved away condition and an angularly moved close condition relative to said outlet mouth;
a shutter portion, which pivots relative to said rotary portion around a pivoting axis lying on a plane transverse relative to said rotation axis; and
an actuating apparatus, for moving said rotary portion between said moved away condition and said moved close condition;
said shutter portion being suited to pivot around said pivoting axis from an open position, in which said shutter portion is spaced apart from said outlet mouth, thus freeing said outlet mouth, to a closed position, in which said shutter portion lies against said outlet mouth, thus obstructing said outlet mouth, when said rotary portion shifts from said moved away condition to said moved close condition.

2. The device according to claim 1, wherein said rotation axis is substantially orthogonal to the plane on which said pivoting axis lies.

3. The device according to claim 1, wherein said shutter portion comprises a striker area, capable of being pushed by a corresponding supporting portion, when said rotary portion moved from said moved away condition to said moved close condition, so as to cause said shutter portion to rotate, thus shifting from said open position to said closed position.

4. The device according to claim 1, further comprising detecting means for cooperating with said rotary portion and for signaling that said rotary portion is in at least one condition between said moved away condition and said moved close condition.

5. The device according to detecting means comprise at least one switch, capable of being operated by said rotary portion, when said rotary portion reaches at least one condition between said moved away condition and said moved close condition.

6. The device according to claim 5, wherein said detecting means comprise an opening switch and a closing switch, capable of being operated by said rotary portion, when said rotary portion reaches said moved away condition and said moved close condition, respectively.

7. The device according to claim 1, wherein said rotary portion comprises a lever (30), which is mounted so as to rotate around said rotation axis.

8. The device according to claim 7, comprises a support arm,on which said shutter portion is mounted so as to rotate around said pivoting axis.

9. The device according to claim 7, wherein said lever comprises a detecting arm, which cooperates with said detecting means so as to signal that said rotary portion is in at least one condition between said moved away condition and said moved close condition.

10. The device according to claim 8, wherein said lever is a rocker arm, which is mounted so as to rotate in said support structure around the rotation axis, and wherein the support arm and the detecting arm project relative to said rotation axis.

11. The device according to claim 1, wherein said actuating apparatus comprises a motor assembly, for controlling the rotation of said rotary portion around said rotation axis.

12. The device according to claim 11, wherein said motor assembly controls rotation of an output shaft, which is caused to rotate around the rotation axis together with said rotary portion in an integral manner.

13. The device according to claim 1, further comprising an adjusting system, for adjusting at least one between orientation and distance of said support structure relative to said outlet mouth.

14. The device according to claim 13, wherein said adjusting system comprises at least one upright, fixed to said support structure and connected to said dispenser in an adjustable manner.

15. The device according to claim 1, wherein said shutter portion comprises a holding tank and a tampon, which is inserted into said holding tank and for being soaked with liquid, so as to prevent the fluid arranged close to said outlet mouth from drying up, when said shutter portion is in said closed position.

16. The device according to claim 15, wherein said shutter portion has a bottom that can be coupled to said holding tank in a removable manner.

17. The device according to claim 1, wherein said shutter portion comprises a gasket, for ensuring better sealing and coupling of said outlet mouth, when said shutter portion is in said closed position.

18. A fluid dispenser having an outlet mouth and comprising a device to close said outlet mouth according to claim 1.
